(19) United States
(12) Patent Application Publication
(10) Pub. No.: US 2025/0212116 A1
(43) Pub. Date: Jun. 26, 2025

(54) AI/ML-BASED NETWORK ENERGY SAVING SYSTEM

(71) Applicants: Lili Wei, Portland, OR (US); Yizhi Yao, Chandler, AZ (US); Omid Semiari, Santa Clara, CA (US); Hosein Nikopour, San Jose, CA (US)

(72) Inventors: Lili Wei, Portland, OR (US); Yizhi Yao, Chandler, AZ (US); Omid Semiari, Santa Clara, CA (US); Hosein Nikopour, San Jose, CA (US)

(21) Appl. No.: 19/076,525

(22) Filed: Mar. 11, 2025

Related U.S. Application Data
(60) Provisional application No. 63/566,116, filed on Mar. 15, 2024.

(51) Int. Cl. H04W 52/02; H04L 41/16; H04W 24/10; H04W 76/20

(52) U.S. Cl. CPC H04W 52/0206; H04L 41/16; H04W 24/10; H04W 76/20

(57) ABSTRACT

Systems and methods are disclosed for a comprehensive framework for managing energy consumption to energy cost index mapping rules in next-generation radio access networks (NG-RAN) enables operators to configure unified mapping rules for groups of gNBs to optimize network energy efficiency through artificial intelligence/machine language (AI/ML)-based decisions. The framework includes multiple mapping approaches for both current and future releases, including linear mapping, mapping tables, and enhanced mapping methods that incorporate additional load parameters. The management service architecture supports both standalone and embedded management functions, allowing operators to create, modify, and delete mapping rules while maintaining coordination among gNB groups. The system facilitates AI/ML-driven energy saving actions by enabling gNBs to interpret and compare energy cost information from neighboring nodes without additional conversion, supporting intelligent traffic offloading decisions to optimize overall network energy efficiency.

### PRIORITY CLAIM

This application claims the benefit of priority to U.S. Provisional Patent Application Ser. No. 63/566,116, filed Mar. 15, 2024, which is incorporated herein by reference in its entirety.

### TECHNICAL FIELD

Embodiments pertain to wireless networks and wireless communications. Some embodiments relate to energy saving in artificial intelligence/machine language (AI/ML)-based network systems.

### BACKGROUND

Mobile communication has evolved significantly from early voice systems to highly sophisticated integrated communication platform. Next-generation (NG) wireless communication systems, including 5^{th} generation (5G) and sixth generation (6G) or new radio (NR) systems, are to provide access to information and sharing of data by various UEs and applications. NR is to be a unified network/system that is to meet vastly different and sometimes conflicting performance dimensions and services driven by different services and applications. As such, the complexity of such communication systems, as well as interactions between elements within a communication system, has increased. AI/ML may be used in a variety of techniques to improve operations of the network.

### BRIEF DESCRIPTION OF THE DRAWINGS

The present disclosure is illustrated by way of example and not limitation in the figures of the accompanying drawings, in which like references indicate similar elements and in which:

FIG. 1A illustrates an architecture of a network, in accordance with some aspects.

FIG. 1B illustrates a non-roaming 5G system architecture in accordance with some aspects.

FIG. 1C illustrates a non-roaming 5G system architecture in accordance with some aspects.

FIG. 2 illustrates a block diagram of a communication device in accordance with some embodiments.

FIG. 3 illustrates a functional framework for RAN intelligence in accordance with some aspects.

FIG. 4 illustrates model training and inference in different entities in accordance with some aspects.

FIG. 5 illustrates model training and inference in the same entity in accordance with some aspects.

FIG. 6 illustrates traffic migration for energy saving in accordance with some aspects.

FIG. 7 illustrates different gNB groups with different mapping rules in accordance with some aspects.

FIG. 8 illustrates an enhanced linear mapping with steps in accordance with some aspects.

FIG. 9 illustrates a management service (MnS) framework for managing the energy consumption to energy cost index mapping rule using a standalone management function (MnF) in accordance with some aspects.

FIG. 10 illustrates a management service (MnS) framework for managing the energy consumption to energy cost index mapping rule using an embedded MnF in accordance with some aspects.

FIG. 11 illustrates a Network Resource Model (NRM) fragment for NG-RAN energy saving group in accordance with some aspects.

FIG. 12 illustrates an inheritance hierarchy for NG-RAN energy saving group in accordance with some aspects.

### DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in or substituted for, those of other embodiments. Embodiments outlined in the claims encompass all available equivalents of those claims.

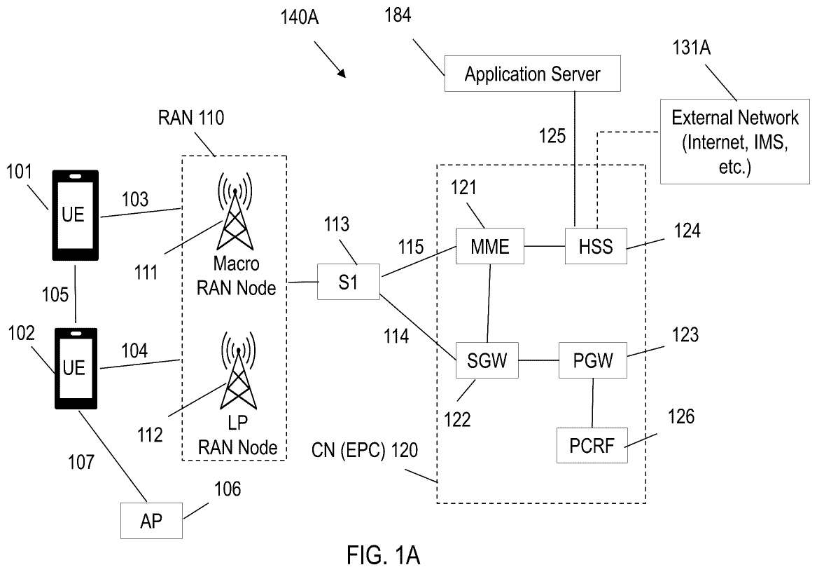

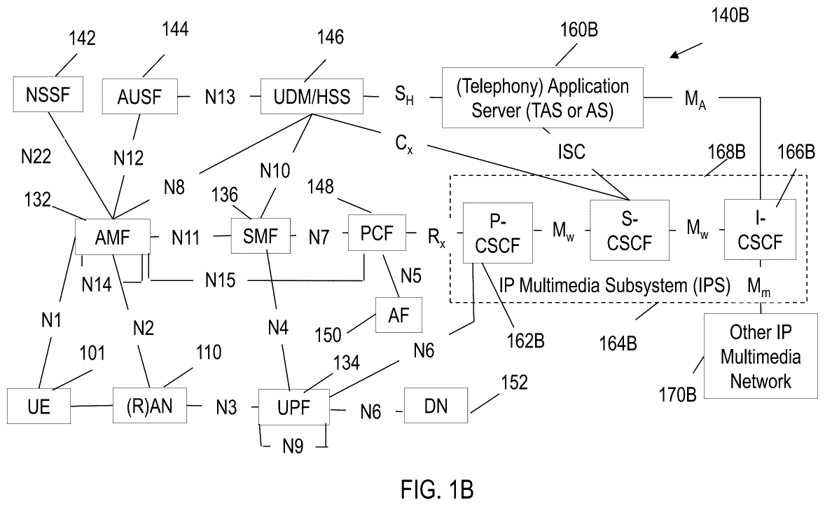

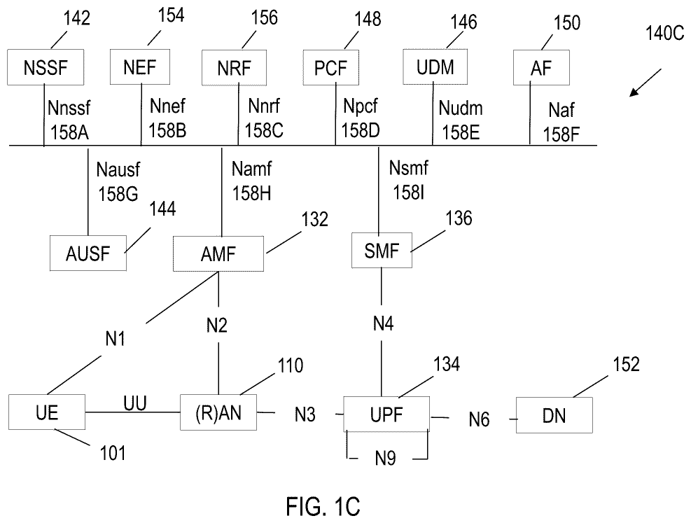

FIG. 1A illustrates an architecture of a network in accordance with some aspects. The network 140A includes 3GPP LTE/4G and NG network functions that may be extended to 6G functions. Accordingly, although 5G will be referred to, it is to be understood that this is to extend as able to 6G structures, systems, and functions. A network function may be implemented as a discrete network element on a dedicated hardware, as a software instance running on dedicated hardware, and/or as a virtualized function instantiated on an appropriate platform, e.g., dedicated hardware or a cloud infrastructure.

The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as portable (laptop) or desktop computers, wireless handsets, drones, or any other computing device including a wired and/or wireless communications interface. The UEs 101 and 102 may be collectively referred to herein as UE 101, and UE 101 may be used to perform one or more of the techniques disclosed herein.

Any of the radio links described herein (e.g., as used in the network 140A or any other illustrated network) may operate according to any exemplary radio communication technology and/or standard. Any spectrum management scheme including, for example, dedicated licensed spectrum, unlicensed spectrum, (licensed) shared spectrum (such as Licensed Shared Access (LSA) in 2.3-2.4 GHz, 3.4-3.6 GHz, 3.6-3.8 GHz, and other frequencies and Spectrum Access System (SAS) in 3.55-3.7 GHz and other frequencies). Different Single Carrier or Orthogonal Frequency Domain Multiplexing (OFDM) modes (CP-OFDM, SC-FDMA, SC-OFDM, filter bank-based multicarrier (FBMC), OFDMA, etc.), and in particular 3GPP NR, may be used by allocating the OFDM carrier data bit vectors to the corresponding symbol resources.

In some aspects, any of the UEs 101 and 102 can comprise an Internet-of-Things (IoT) UE or a Cellular IoT (CIoT) UE, which can comprise a network access layer designed for low-power IoT applications utilizing short-lived UE connections. In some aspects, any of the UEs 101 and 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network. In some aspects, any of the UEs 101 and 102 can include enhanced MTC (eMTC) UEs or further enhanced MTC (FeMTC) UEs.

The UEs 101 and 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN.

The UEs 101 and 102 utilize connections 103 and 104, respectively, each of which comprises a physical communications interface or layer (discussed in further detail below); in this example, the connections 103 and 104 are illustrated as an air interface to enable communicative coupling, and may be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a 5G protocol, a 6G protocol, and the like.

In an aspect, the UEs 101 and 102 may further directly exchange communication data via a ProSe interface 105. The ProSe interface 105 may alternatively be referred to as a sidelink (SL) interface comprising one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), and a Physical Sidelink Feedback Channel (PSFCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi®) router. In this example, the AP 106 is shown to be connected to the Internet without connecting to the core network of the wireless system (described in further detail below).

The RAN 110 can include one or more access nodes that enable the connections 103 and 104. These access nodes (ANs) may be referred to as base stations (BSs), NodeBs, evolved NodeBs (eNBs), Next Generation NodeBs (gNBs), RAN nodes, and the like, and can comprise ground stations (e.g., terrestrial access points) or satellite stations providing coverage within a geographic area (e.g., a cell). In some aspects, the communication nodes 111 and 112 may be transmission/reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN node 111, and one or more RAN nodes for providing femtocells or picocells (e.g., cells having smaller coverage areas, smaller user capacity, or higher bandwidth compared to macrocells), e.g., low power (LP) RAN node 112.

Any of the RAN nodes 111 and 112 can terminate the air interface protocol and may be the first point of contact for the UEs 101 and 102. In some aspects, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management. In an example, any of the nodes 111 and/or 112 may be a gNB, an eNB, or another type of RAN node.

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the RAN nodes 111 and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the CN 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VoIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some aspects, the communication network 140A may be an IoT network or a 5G or 6G network, including 5G new radio network using communications in the licensed (5G NR) and the unlicensed (5G NR-U) spectrum. One of the current enablers of IoT is the narrowband-IoT (NB-IoT). Operation in the unlicensed spectrum may include dual connectivity (DC) operation and the standalone LTE system in the unlicensed spectrum, according to which LTE-based technology solely operates in unlicensed spectrum without the use of an “anchor” in the licensed spectrum, called MulteFire. Further enhanced operation of LTE systems in the licensed as well as unlicensed spectrum is expected in future releases and 5G systems. Such enhanced operations can include techniques for sidelink resource allocation and UE processing behaviors for NR sidelink V2X communications.

An NG system architecture (or 6G system architecture) can include the RAN 110 and a 5G core network (5GC) 120. The NG-RAN 110 can include a plurality of nodes, such as gNBs and NG-eNBs. The CN 120 (e.g., a 5G core network/5GC) can include an access and mobility function (AMF) and/or a user plane function (UPF). The AMF and the UPF may be communicatively coupled to the gNBs and the NG-eNBs via NG interfaces. More specifically, in some aspects, the gNBs and the NG-eNBs may be connected to the AMF by NG-C interfaces, and to the UPF by NG-U interfaces. The gNBs and the NG-eNBs may be coupled to each other via Xn interfaces.

In some aspects, the NG system architecture can use reference points between various nodes. In some aspects, each of the gNBs and the NG-eNBs may be implemented as a base station, a mobile edge server, a small cell, a home eNB, and so forth. In some aspects, a gNB may be a master node (MN) and NG-eNB may be a secondary node (SN) in a 5G architecture.

FIG. 1B illustrates a non-roaming 5G system architecture in accordance with some aspects. In particular, FIG. 1B illustrates a 5G system architecture 140B in a reference point representation, which may be extended to a 6G system architecture. More specifically, UE 102 may be in communication with RAN 110 as well as one or more other 5GC network entities. The 5G system architecture 140B includes a plurality of network functions (NFs), such as an AMF 132, session management function (SMF) 136, policy control function (PCF) 148, application function (AF) 150, UPF 134, network slice selection function (NSSF) 142, authentication server function (AUSF) 144, and unified data management (UDM)/home subscriber server (HSS) 146.

The UPF 134 can provide a connection to a data network (DN) 152, which can include, for example, operator services, Internet access, or third-party services. The AMF 132 may be used to manage access control and mobility and can also include network slice selection functionality. The AMF 132 may provide UE-based authentication, authorization, mobility management, etc., and may be independent of the access technologies. The SMF 136 may be configured to set up and manage various sessions according to network policy. The SMF 136 may thus be responsible for session management and allocation of IP addresses to UEs. The SMF 136 may also select and control the UPF 134 for data transfer. The SMF 136 may be associated with a single session of a UE 101 or multiple sessions of the UE 101. This is to say that the UE 101 may have multiple 5G sessions. Different SMFs may be allocated to each session. The use of different SMFs may permit each session to be individually managed. As a consequence, the functionalities of each session may be independent of each other.

The UPF 134 may be deployed in one or more configurations according to the desired service type and may be connected with a data network. The PCF 148 may be configured to provide a policy framework using network slicing, mobility management, and roaming (similar to PCRF in a 4G communication system). The UDM may be configured to store subscriber profiles and data (similar to an HSS in a 4G communication system).

The AF 150 may provide information on the packet flow to the PCF 148 responsible for policy control to support a desired QoS. The PCF 148 may set mobility and session management policies for the UE 101. To this end, the PCF 148 may use the packet flow information to determine the appropriate policies for proper operation of the AMF 132 and SMF 136. The AUSF 144 may store data for UE authentication.

In some aspects, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162B, a serving CSCF (S-CSCF) 164B, an emergency CSCF (E-CSCF) (not illustrated in FIG. 1B), or interrogating CSCF (I-CSCF) 166B. The P-CSCF 162B may be configured to be the first contact point for the UE 102 within the IM subsystem (IMS) 168B. The S-CSCF 164B may be configured to handle the session states in the network, and the E-CSCF may be configured to handle certain aspects of emergency sessions such as routing an emergency request to the correct emergency center or PSAP. The I-CSCF 166B may be configured to function as the contact point within an operator's network for all IMS connections destined to a subscriber of that network operator, or a roaming subscriber currently located within that network operator's service area. In some aspects, the I-CSCF 166B may be connected to another IP multimedia network 170B, e.g., an IMS operated by a different network operator.

In some aspects, the UDM/HSS 146 may be coupled to an application server 184, which can include a telephony application server (TAS) or another application server (AS) 160B. The AS 160B may be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM 146 and the AMF 132, not shown), N9 (between two UPFs 134, not shown), N10 (between the UDM 146 and the SMF 136, not shown), N11 (between the AMF 132 and the SMF 136, not shown), N12 (between the AUSF 144 and the AMF 132, not shown), N13 (between the AUSF 144 and the UDM 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some aspects, 5G system architectures may be service-based and interaction between network functions may be represented by corresponding point-to-point reference points Ni or as service-based interfaces.

In some aspects, as illustrated in FIG. 1C, service-based representations may be used to represent network functions within the control plane that enable other authorized network functions to access their services. In this regard, 5G system architecture 140C can include the following service-based interfaces: Namf 158H (a service-based interface exhibited by the AMF 132), Nsmf 1581 (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

NR-V2X architectures may support high-reliability low latency sidelink communications with a variety of traffic patterns, including periodic and aperiodic communications with random packet arrival time and size. Techniques disclosed herein may be used for supporting high reliability in distributed communication systems with dynamic topologies, including sidelink NR V2X communication systems.

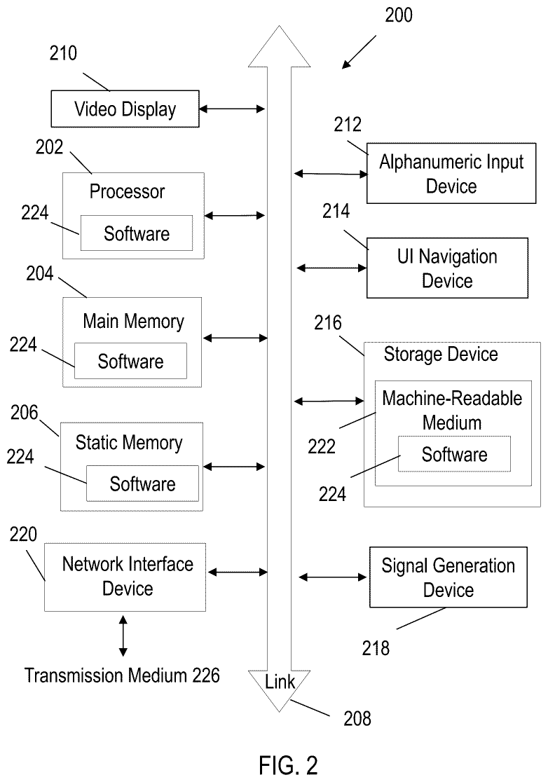

FIG. 2 illustrates a block diagram of a communication device in accordance with some embodiments. The communication device 200 may be a UE such as a specialized computer, a personal or laptop computer (PC), a tablet PC, or a smart phone, dedicated network equipment such as an eNB, a server running software to configure the server to operate as a network device, a virtual device, or any machine capable of executing instructions (sequential or otherwise) that specify actions to be taken by that machine. For example, the communication device 200 may be implemented as one or more of the devices shown in FIGS. 1A-IC. Note that communications described herein may be encoded before transmission by the transmitting entity (e.g., UE, gNB) for reception by the receiving entity (e.g., gNB, UE) and decoded after reception by the receiving entity.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The communication device 200 may include a hardware processor (or equivalently processing circuitry) 202 (e.g., a central processing unit (CPU), a GPU, a hardware processor core, or any combination thereof), a main memory 204 and a static memory 206, some or all of which may communicate with each other via an interlink (e.g., bus) 208. The main memory 204 may contain any or all of removable storage and non-removable storage, volatile memory or non-volatile memory. The communication device 200 may further include a display unit 210 such as a video display, an alphanumeric input device 212 (e.g., a keyboard), and a user interface (UI) navigation device 214 (e.g., a mouse). In an example, the display unit 210, input device 212 and UI navigation device 214 may be a touch screen display. The communication device 200 may additionally include a storage device (e.g., drive unit) 216, a signal generation device 218 (e.g., a speaker), a network interface device 220, and one or more sensors, such as a global positioning system (GPS) sensor, compass, accelerometer, or another sensor. The communication device 200 may further include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a non-transitory machine readable medium 222 (hereinafter simply referred to as machine readable medium) on which is stored one or more sets of data structures or instructions 224 (e.g., software) embodying or utilized by any one or more of the techniques or functions described herein. The non-transitory machine readable medium 222 is a tangible medium. The instructions 224 may also reside, completely or at least partially, within the main memory 204, within static memory 206, and/or within the hardware processor 202 during execution thereof by the communication device 200. While the machine readable medium 222 is illustrated as a single medium, the term “machine readable medium” may include a single medium or multiple media (e.g., a centralized or distributed database, and/or associated caches and servers) configured to store the one or more instructions 224.

The term “machine readable medium” may include any medium that is capable of storing, encoding, or carrying instructions for execution by the communication device 200 and that cause the communication device 200 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks.

The instructions 224 may further be transmitted or received over a communications network using a transmission medium 226 via the network interface device 220 utilizing any one of a number of wireless local area network (WLAN) transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks. Communications over the networks may include one or more different protocols, such as Institute of Electrical and Electronics Engineers (IEEE) 802.11 family of standards known as Wi-Fi, IEEE 802.16 family of standards known as WiMax, IEEE 802.15.4 family of standards, a Long Term Evolution (LTE) family of standards, a Universal Mobile Telecommunications System (UMTS) family of standards, peer-to-peer (P2P) networks, a next generation (NG)/5^{th} generation (5G) standards among others. In an example, the network interface device 220 may include one or more physical jacks (e.g., Ethernet, coaxial, or phone jacks) or one or more antennas to connect to the transmission medium 226.

Note that the term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” or “processor” as used herein thus refers to, is part of, or includes circuitry capable of sequentially and automatically carrying out a sequence of arithmetic or logical operations, or recording, storing, and/or transferring digital data. The term “processor circuitry” or “processor” may refer to one or more application processors, one or more baseband processors, a physical central processing unit (CPU), a single- or multi-core processor, and/or any other device capable of executing or otherwise operating computer-executable instructions, such as program code, software modules, and/or functional processes.

Any of the radio links described herein may operate according to any one or more of the following radio communication technologies and/or standards including but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17) and subsequent Releases (such as Rel. 18, Rel. 19, etc.), 3GPP 5G, 5G, 5G New Radio (5G NR), 3GPP 5G New Radio, 3GPP LTE Extra, LTE-Advanced Pro, LTE Licensed-Assisted Access (LAA), MuLTEfire, UMTS Terrestrial Radio Access (UTRA), Evolved UMTS Terrestrial Radio Access (E-UTRA), Long Term Evolution Advanced (4th Generation) (LTE Advanced (4G)), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as 3GPP Generic Access Network, or GAN standard), Zigbee, Bluetooth®, Wireless Gigabit Alliance (WiGig) standard, mmWave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p or IEEE 802.11bd and other) Vehicle-to-Vehicle (V2V) and Vehicle-to-X (V2X) and Vehicle-to-Infrastructure (V2I) and Infrastructure-to-Vehicle (I2V) communication technologies, 3GPP cellular V2X, DSRC (Dedicated Short Range Communications) communication systems such as Intelligent-Transport-Systems and others (typically operating in 5850 MHz to 5925 MHz or above (typically up to 5935 MHz following change proposals in CEPT Report 71)), the European ITS-G5 system (i.e. the European flavor of IEEE 802.11p based DSRC, including ITS-G5A (i.e., Operation of ITS-G5 in European ITS frequency bands dedicated to ITS for safety related applications in the frequency range 5,875 GHz to 5,905 GHz), ITS-G5B (i.e., Operation in European ITS frequency bands dedicated to ITS non-safety applications in the frequency range 5,855 GHz to 5,875 GHz), ITS-G5C (i.e., Operation of ITS applications in the frequency range 5,470 GHz to 5,725 GHz)), DSRC in Japan in the 700 MHz band (including 715 MHz to 725 MHz), IEEE 802.11bd based systems, etc.

Aspects described herein may be used in the context of any spectrum management scheme including dedicated licensed spectrum, unlicensed spectrum, license exempt spectrum, (licensed) shared spectrum (such as LSA=Licensed Shared Access in 2.3-2.4 GHz, 3.4-3.6 GHz, 3.6-3.8 GHz and further frequencies and SAS=Spectrum Access System/CBRS=Citizen Broadband Radio System in 3.55-3.7 GHz and further frequencies). Applicable spectrum bands include IMT (International Mobile Telecommunications) spectrum as well as other types of spectrum/bands, such as bands with national allocation (including 450-470 MHz, 902-928 MHz (note: allocated for example in US (FCC Part 15)), 863-868.6 MHz (note: allocated for example in European Union (ETSI EN 300 220)), 915.9-929.7 MHz (note: allocated for example in Japan), 917-923.5 MHz (note: allocated for example in South Korea), 755-779 MHz and 779-787 MHz (note: allocated for example in China), 790-960 MHz, 1710-2025 MHz, 2110-2200 MHz, 2300-2400 MHz, 2.4-2.4835 GHz (note: it is an ISM band with global availability and it is used by Wi-Fi technology family (11b/g/n/ax) and also by Bluetooth), 2500-2690 MHz, 698-790 MHz, 610-790 MHz, 3400-3600 MHz, 3400-3800 MHz, 3800-4200 MHz, 3.55-3.7 GHz (note: allocated for example in the US for Citizen Broadband Radio Service), 5.15-5.25 GHz and 5.25-5.35 GHz and 5.47-5.725 GHz and 5.725-5.85 GHz bands (note: allocated for example in the US (FCC part 15), consists four U-NII bands in total 500 MHz spectrum), 5.725-5.875 GHz (note: allocated for example in EU (ETSI EN 301 893)), 5.47-5.65 GHz (note: allocated for example in South Korea, 5925-7125 MHz and 5925-6425 MHz band (note: under consideration in US and EU, respectively. Next generation Wi-Fi system is expected to include the 6 GHz spectrum as operating band, but it is noted that, as of December 2017, Wi-Fi system is not yet allowed in this band. Regulation is expected to be finished in 2019-2020 time frame), IMT-advanced spectrum, IMT-2020 spectrum (expected to include 3600-3800 MHz, 3800-4200 MHz, 3.5 GHz bands, 700 MHz bands, bands within the 24.25-86 GHz range, etc.), spectrum made available under FCC's “Spectrum Frontier” 5G initiative (including 27.5-28.35 GHz, 29.1-29.25 GHz, 31-31.3 GHz, 37-38.6 GHz, 38.6-40 GHz, 42-42.5 GHz, 57-64 GHz, 71-76 GHz, 81-86 GHz and 92-94 GHz, etc.), the ITS (Intelligent Transport Systems) band of 5.9 GHz (typically 5.85-5.925 GHz) and 63-64 GHz, bands currently allocated to WiGig such as WiGig Band 1 (57.24-59.40 GHz), WiGig Band 2 (59.40-61.56 GHz) and WiGig Band 3 (61.56-63.72 GHz) and WiGig Band 4 (63.72-65.88 GHz), 57-64/66 GHz (note: this band has near-global designation for Multi-Gigabit Wireless Systems (MGWS)/WiGig. In US (FCC part 15) allocates total 14 GHz spectrum, while EU (ETSI EN 302 567 and ETSI EN 301 217-2 for fixed P2P) allocates total 9 GHz spectrum), the 70.2 GHz-71 GHz band, any band between 65.88 GHz and 71 GHz, bands currently allocated to automotive radar applications such as 76-81 GHz, and future bands including 94-300 GHz and above. Furthermore, the scheme may be used on a secondary basis on bands such as the TV White Space bands (typically below 790 MHz) where in particular the 400 MHz and 700 MHz bands are promising candidates. Besides cellular applications, specific applications for vertical markets may be addressed such as PMSE (Program Making and Special Events), medical, health, surgery, automotive, low-latency, drones, etc. applications.

As above, AI/ML-based techniques may be used to improve network operations in a variety of ways. In general, AI/ML algorithms provide powerful tools to help operators analyze RAN data, optimize network resource management, and ultimately enhance user experience. Although most of the AI algorithms can be up to implementation, the signaling support for AI deserves study of the training and the execution in AI schemes, the data used by the AI algorithms, and outputs generated by the algorithms to be delivered to other network nodes or NFs in RAN, CN, or Operations Administration and Maintenance (OAM).

For example, AI/ML-based network energy saving is one of the use cases to optimize overall energy efficiency of the coverage of a NG-RAN node and its neighbors. Previously, the energy efficiency (EE) was defined as the data volume (DV) divided by energy consumption (EC) of the considered network elements. However, for a particular gNB, the gNB can only measure its own single-node EE based on its own DV and EC and inform its neighbors. That is, the energy cost is only related to the measured energy consumption of a RAN node with its current load. Since AI/ML based energy saving aims to optimize the overall energy efficiency of the coverage of a NG-RAN node and its neighbors, this EE metric for a single gNB alone can be difficult to be interpreted by other neighboring gNBs and can lead to ambiguities in calculating the overall EE across several gNBs. However, there is no mapping rule defined from energy consumption related to an additional load to the energy cost index.

Accordingly, the AI/ML metric of energy cost index is introduced to overcome this, with the metric being exchanged between NG-RAN nodes. AI/ML-driven energy saving actions at one gNB are based on a historical pattern of energy cost information from neighboring gNBs before and after the traffic offloading. In NG-RAN, energy saving is performed by coordination of a group of gNBs. The mapping rule from energy consumption to the energy cost index is provided and configured by operator, and the same rule is applied by all the gNBs belonging to same group. The system allows the operator to provide multiple mapping rules with each one working on a certain condition (e.g., time window), and the gNBs within the same group select and use the same rule at the same time.

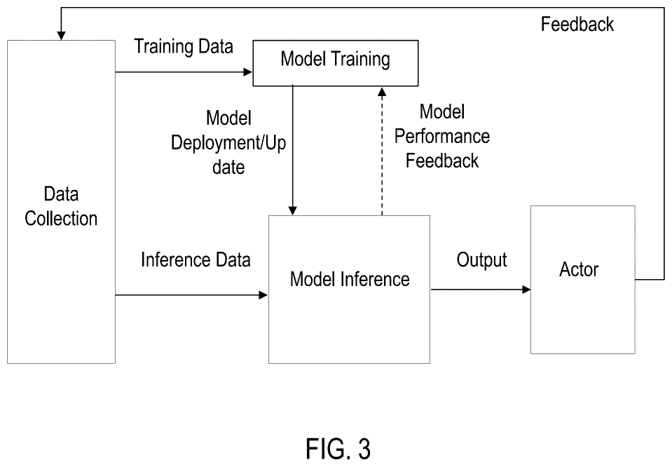

FIG. 3 illustrates a functional framework for RAN intelligence in accordance with some aspects. The functional framework for RAN intelligence in FIG. 3 is illustrated with different functions, including data collection, model training, model inference, and actor. Data collection is a function that provides input data to model training and model inference functions. Examples of input data may include measurements from UEs or different network entities, feedback from the actor, output from an AI/ML model. Model training is a function that performs the AI/ML model training, validation and testing which may generate model performance metrics as part of the model testing procedure. Model inference is a function that provides AI/ML model inference output (e.g., predictions or decisions). Model inference function may provide model performance feedback to model training function when applicable. The actor function is a function that receives the output from the model inference function and triggers or performs corresponding actions.

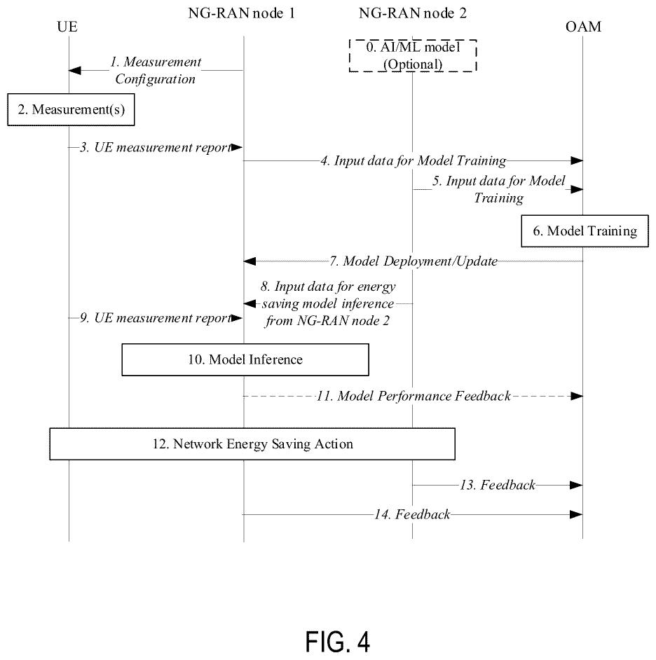

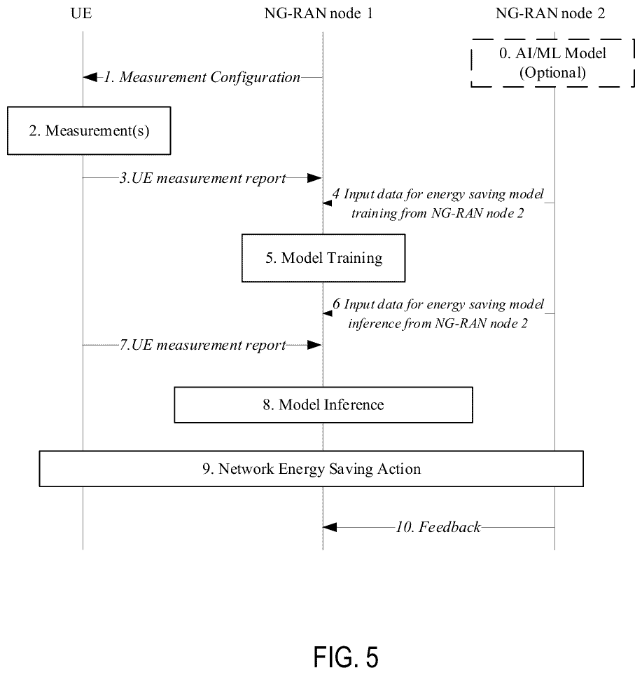

FIG. 4 illustrates model training and inference in different entities in accordance with some aspects. FIG. 5 illustrates model training and inference in the same entity in accordance with some aspects. The solutions in FIGS. 4 and 5 support AI/ML-based network energy saving. In particular, in FIG. 4, AI/ML model training is located in the OAM and AI/ML model inference is located in the gNB; in FIG. 5, AI/ML model training and AI/ML model inference are both located in the gNB.

In FIG. 4, the process begins at operation 1 with NG-RAN node 1 (the serving NG-RAN node) providing the measurement configuration to the UE. The AI/ML model may be established at NG-RAN node 2. At operation 2, the UE collects the measurements indicated by the measurement configuration, followed by operation 3, in which the UE sends a measurement report directly to NG-RAN node 1. At operations 4 and 5, NG-RAN node 1 and NG-RAN node 2 respectfully provide input data for model training to the OAM system. At operation 6, the OAM system performs training of the AI/ML model. After training, the OAM deploys or updates the model to NG-RAN node 1 at operation 7. At operation 8, NG-RAN node 2 provides input data specifically for energy saving model inference to NG-RAN node 1, while at operation 9 the UE continues to send measurement reports to NG-RAN node 1. At operation 10, NG-RAN node 1 then performs model inference using the deployed AI/ML model and at operation 11 sends performance feedback of the AI/ML model to the OAM system. Based on the inference results, NG-RAN node 1 (and NG-RAN node 2 and the UE) execute network energy saving actions at operation 12 based on the AI/ML model. Operations 13 and 14 involve a feedback loop where respectively NG-RAN node 2 and NG-RAN node 1 sends feedback about the energy saving actions to the OAM system for continuous improvement of the AI/ML model.

In FIG. 5, the process begins at operation 1 with NG-RAN node 1 (the serving NG-RAN node) providing the measurement configuration to the UE. The AI/ML model may be established at NG-RAN node 2. At operation 2, the UE collects the measurements indicated by the measurement configuration, followed by operation 3, in which the UE sends a measurement report directly to NG-RAN node 1. At operation 4, NG-RAN node 2 provides input data for model training to NG-RAN node 1. At operation 5, NG-RAN node 1 performs training of the AI/ML model. At operation 6, NG-RAN node 2 provides input data specifically for energy saving model inference to NG-RAN node 1, while at operation 7 the UE continues to send measurement reports to NG-RAN node 1. At operation 8, NG-RAN node 1 then performs model inference using the deployed AI/ML model. Based on the inference results, NG-RAN node 1 (and NG-RAN node 2 and the UE) execute network energy saving actions at operation 9 based on the AI/ML model. At operation 10 NG-RAN node 1 receives feedback about the energy saving actions from NG-RAN node 2 for continuous improvement of the AI/ML model.

One of the NG-RAN data EE metrics for a mobile network (MN) is obtained by the DV divided by EC of the considered network elements as follows:

$${EE}_{MN , DV} {=}^{Δ} \frac{{DV}_{MN}}{{EC}_{MN}}$$

As noted above, each gNB may only measure its own single-node EE based on its own DV and EC and inform its neighbors. However, this EE metric of a single gNB can be difficult interpret by other neighboring gNBs and can lead to ambiguities in calculating the overall EE across a group of gNBs. In addition, actions taken regarding the EE metric of a single gNB may produce a local improvement of energy efficiency, while producing an overall (e.g., involving multiple RAN nodes) deterioration of energy efficiency. This leads to a RAN node being unable to get the overall DV/EC quotient by operating with individual DV/EC quotients. Example cases include:
Case A: Node1: DV=200, EC=20, DV/EC=10; Node2: DV=80, EC=80, DV/EC=1; overall DV/EC=2.8.

Case B: Node1: DV=800, EC=80, DV/EC=10; Node2: DV=20, EC=20, DV/EC=1; overall DV/EC=8.2.

For both Case A and Case B, Node 1 has the same DV/EC=10 value and Node 2 has the same DV/EC=1 value. Although Node3 receives DV/EC=10 from Node1 and DV/EC=1 form Node2, it is still not sure whether the overall DV/EC is 2.8 or 8.2.

Thus, optimization of the overall energy efficiency of the coverage of a gNB and its neighbors, i.e., a sum of DV_{MN} over a group of gNBs divided by a sum of EC_{MN} over the same group of gNBs, is provided. This leads to the energy cost index being introduced as AI/ML metric for energy efficiency to be exchanged between NG-RAN nodes, i.e., over Xn interface among gNBs. The metric of energy cost exchanged between NG-RAN nodes can be an inferred energy consumption related to an additional load or an actual energy consumption value from a neighboring node for either additional load or current load. The energy cost is a node level parameter, that is, a value at the gNB level. The energy cost is included in the AI/ML Information Reporting Initiation and AI/ML Information Reporting procedures. The energy cost is represented as an index, which is normalized and defined by the OAM. The index value may be encoded as an integer from 0 to a maximum value. The maximum value is sufficient to guarantee a predetermined amount of accuracy. The energy cost information element (IE) is defined as an integer (0 . . . 10000 . . . ) and may be revisited based on reply from SA5.

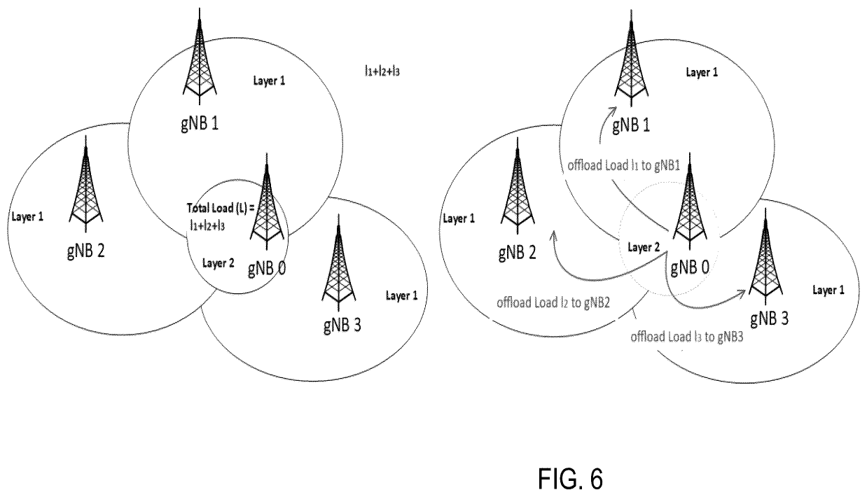

Energy saving schemes (cell activation/deactivation, cell reduction of load, etc.) may exploit traffic offloading in a layered structure to reduce the energy consumption of a group of gNBs. In particular, FIG. 6 illustrates traffic migration from a source node (gNB0) to its neighboring target nodes (gNB1/gNB2/gNB3). To make an intelligent energy saving decision, an AI/ML model is to evaluate the triggering condition that the estimated combined amount of energy consumed at the target nodes (gNB1/gNB2/gNB3) for the additional offloading traffic from the source node (gNB0) is less than the amount of energy consumed at the source node for the same traffic volume. Accordingly, the energy cost provides a representation of the energy consumption at an NG-RAN node. The NG-RAN nodes exchange the energy cost with neighboring NG-RAN nodes upon request. The energy cost is encoded as an index, normalized by rules provided by OAM. The energy cost index is thus exchanged between gNBs as input/feedback to evaluate for AI/ML-driven energy saving actions. The mapping rule from energy consumption to energy cost is provided by the OAM. The rules are the same at least for all neighboring NG-RAN nodes within the area where a request on energy cost reporting is triggered by a NG-RAN node. Based on this, the NG-RAN nodes are configured with a unified rule to map the energy cost value of the NG-RAN node to a measurement of consumed energy ensuring normalization of the exchanged energy cost information.

A non-split NG-RAN node is capable of self-measurement of its energy consumption and then is able to derive the corresponding energy cost, the latter being a dimensionless index which is derived on the basis of averaged measurements of the NG-RAN node's consumed energy. It is up to the OAM to configure the energy consumption values corresponding to the minimum and maximum energy cost index values. The OAM provides by configuration a recommended time interval within which to perform the average. The same time interval is configured by the OAM for all gNBs within the defined area. The time interval is configured to limit, within specific time boundaries, the choice of an implementation-specific averaging window size for energy consumption measurements.

While gNBs know their minimum and maximum energy consumption values, value 0 of the energy cost index is associated to a single energy consumption value, configured based on the minimum energy consumption of gNBs in the defined area; value 10,000 of the energy cost index is associated to a single energy consumption value, configured based on the maximum energy consumption of gNBs in the same area. The mapping rule used to convert the gNBs energy consumption into an energy cost index value is unified within the defined area, namely an energy consumption value is unequivocally mapped to an energy cost index value.

The energy consumption values corresponding to the minimum and maximum energy cost index values may or may not correspond to the given gNB's own minimum and maximum energy consumption values. Instead, the minimum and maximum energy cost index values depend on the minimum and maximum energy consumption values among all gNBs within a certain area.

One of the use cases is switching-off a cell and offloading the traffic of the cell to one or more neighboring cells. In FIG. 6, the operator has configured a unified mapping rule around an area of gNB0. gNB0 serves cells deployed to provide capacity, and gNB0 tries to determine whether it is optimal to offload its traffic to one or more of its neighbouring gNBs (gNB1, gNB2 and gNB3) and switch off its cells. To make an optimal AI/ML energy saving decision, gNB0 requests and obtains energy cost information from its neighbours. However, for gNB0 to be able to make the right AI/ML energy saving decision, the energy cost provided by its neighbouring gNBs are derived from their energy consumptions in the same way as its own energy cost is derived from its own energy consumption, so that gNB0 is able to compare whether the overall energy cost, and hence overall energy consumption, in the defined area (gNB0/1/2/3) after the offloading will be no more than the one in the same area before the offloading.

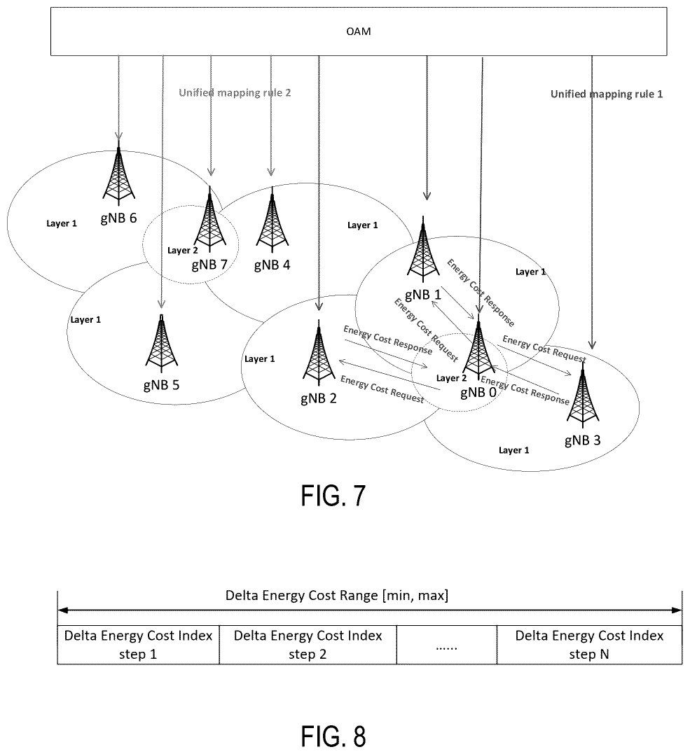

The unified mapping rule thus is common among the gNBs that are involved in an AI/ML offloading action (gNBs serving source cells and gNBs serving target cells for the offloading). The gNB receiving energy cost information from different neighbouring gNBs is able to directly compare the information without additional mapping or conversion. A different unified mapping rule could be defined across other gNBs participating to a different AI/ML offloading. FIG. 7 illustrates different gNB groups with different mapping rules in accordance with some aspects.

The mapping rule between energy consumption values and energy cost index values is defined by the operator and left to implementation. The OAM configuration may enable selection of such operator-defined rules. Note that the AI/ML-driven energy saving actions at one gNB are based on historical pattern of energy cost information from neighboring gNBs before and after the traffic offloading.

Energy consumption at different gNB nodes can have the same EC range. However, different gNB groups can be differentiated by different energy cost index ranges, so that different mapping rules can be applied in different gNB groups.

[ECₘᵢₙ, ECₘₐₓ]: energy consumption range which are common among all gNBs.

[Indexₘᵢₙ, Indexₘₐₓ]: energy cost index range which are different for each group of gNBs.

For example, gNB group 1 can choose the energy cost index range as [0, 100] gNB group 2 can choose the energy cost index range as [50, 200], etc. The operator can define and inform the energy cost index range for different gNB groups. This energy cost index range differentiation for different gNB groups can be applied to different mapping rules described below.

### Linear Mapping

Linear Mapping rule is a straightforward way to map the measured energy consumption of a gNB into the energy cost index as in Eq. (1)

$$Index = Integer ( {P}_{1} * E C + {P}_{2} ) \qquad ( 1 )$$

where:
EC: measured energy consumption at one gNB.
Index: energy cost index mapped from the EC.
P₁, P₂: linear mapping parameters related to the EC range and energy cost index range.

$${P}_{1} = \frac{{Index}_{max} - {Index}_{min}}{{EC}_{max} - {EC}_{min}} \qquad ( 2 )$$

$${P}_{2} = \frac{E {C}_{max} {Index}_{min} - E {C}_{min} {Index}_{max}}{E {C}_{max} - E {C}_{min}}$$

Integer(·): operation to make the result to an integer, can be round (·), ceiling (·), floor (·), etc.

Note that the P₁, P₂ values can be different regarding different gNB groups, since different gNB groups can have different [Indexₘᵢₙ, Indexₘₐₓ] range, hence formulating different linear mapping rules.

### Mapping Table

The mapping table rule is a non-linear mapping between energy consumption and the energy cost index. The mapping table is illustrated in Table 1. Basically, the whole [ECₘᵢₙ, ECₘₐₓ] range is divided into small EC step ranges, while one energy cost index value is applied for each EC step range. Note that the energy cost index range [Indexₘᵢₙ, Indexₘₐₓ] and EC step ranges can be defined by the operator and can be different for different gNB groups.

EC [stepₘᵢₙ⁽ⁱ⁾, stepₘₐₓ⁽ⁱ⁾): The i-th step range of measured Energy Consumption.

TABLE 1
Mapping Table rule illustration

| Energy Consumption (EC) | Energy Cost Index |
|---|---|
| EC [stepₘᵢₙ⁽¹⁾, stepₘₐₓ⁽¹⁾) | Indexₘᵢₙ |
| EC [stepₘᵢₙ⁽²⁾, stepₘₐₓ⁽²⁾) | Indexₘᵢₙ + 1 |
| EC [stepₘᵢₙ⁽³⁾, stepₘₐₓ⁽³⁾) | Indexₘᵢₙ + 2 |
| . . . | . . . |
| EC [stepₘᵢₙ^{(Index}^{ₘₐₓ}^{-Index}^{ₘᵢₙ}⁺¹⁾, | Indexₘₐₓ |
| stepₘₐₓ^{(Index}^{ₘₐₓ}^{-Index}^{ₘᵢₙ}⁺¹⁾] | |

### Energy Consumption to Energy Cost Mapping Rule for Future Release

In future releases, a delta energy cost index can be defined as inferred or measured from delta energy consumption related to an Additional Load. The “Additional Load” can be defined from the following options: number of RRC connections to be offloaded, number of active UEs to be offloaded, physical resource block (PRB) usage to be offloaded, average uplink/downlink (UL/DL) Packet Data Convergence Protocol (PDCP) Service Data Unit (SDU) data volume to be offloaded, and average UE throughput.

The additional load can be either transmitted through the XnAP interface between gNBs or set to a pre-configured value to be known for a group of gNBs.

The delta energy consumption at different gNB nodes can have the same delta energy consumption (AEC) range. However, different gNB groups can be differentiated by different delta energy cost index ranges, so that different mapping rules can be applied in different gNB groups.

[ΔECₘᵢₙ, ΔECₘₐₓ]: delta energy consumption range that is common among all gNBs.

[ΔIndexₘᵢₙ, ΔIndexₘₐₓ]: delta energy cost index range that is different for each group of gNBs.

This delta energy cost index range differentiation for different gNB groups can be applied to different mapping rules described below.

### Enhanced Linear Mapping

In the enhanced linear mapping rule, the delta energy consumption linearly is mapped to the delta energy cost index with respect to the additional load either transmitted through the XnAP interface or a pre-defined amount of additional load.

$$Δ Index = Integer ( {P}_{3} * Δ EC + {P}_{4} ) \qquad ( 3 )$$

ΔEC: Interred or measure delta energy consumption at one gNB related to the additional load.

ΔIndex: delta energy cost index mapped from EC.

P₃, P₄: Enhanced linear mapping parameters related to ΔEC range and ΔIndex range.

$${P}_{3} = \frac{{ΔIndex}_{max} - {ΔIndex}_{min}}{Δ {EC}_{max} - Δ {EC}_{min}} \qquad ( 4 )$$

$${P}_{4} = \frac{Δ E {C}_{max} * {ΔIndex}_{min} - Δ E {C}_{min} * {ΔIndex}_{max}}{Δ E {C}_{max} - Δ E {C}_{min}}$$

Integer(·): operation to make the result to an integer, can be round (·), ceiling (·), floor (·), etc.

Note that the P₃, P₄ values can be different regarding different gNB groups, since different gNB groups can have different [ΔIndexₘᵢₙ, ΔIndexₘₐₓ] ranges, hence formulating different enhanced linear mapping rules.

Enhanced Linear Mapping with Steps

Based on the enhanced linear mapping rule, an enhanced linear mapping may be designed with steps regarding different levels of the additional load. In the enhanced linear mapping with steps, different levels of additional loads can be either transmitted through the XnAP interface or pre-configured, and a gNB can choose to report according to one of the additional load amounts.

$${Δ Index}_{{step}^{( 1 )}} = Intege r ( {P}_{3 , {step}^{( 1 )}} * Δ E {C}_{{step}^{( 1 )}} + {P}_{4 , {step}^{( 1 )}} ) \qquad ( 5 )$$

$${ΔIndex}_{{step}^{( 2 )}} = Integer ( {P}_{3 , {step}^{( 2 )}} * Δ E {C}_{{step}^{( 2 )}} + {P}_{4 , {step}^{( 2 )}} )$$

$$\text{.....}$$

$${ΔIndex}_{{step}^{( N )}} = Integer ( {P}_{3 , {step}^{( N )}} * Δ E {C}_{s t e {p}^{( N )}} + {P}_{4 , {step}^{( N )}} )$$

ΔECₛₜₑₚ_{⁽ⁱ⁾}: inferred or measured delta energy consumption at one gNB for additional load of step⁽ⁱ⁾, with range [ΔECₛₜₑₚ_{⁽ⁱ⁾}_{,min}, ΔECₛₜₑₚ_{⁽ⁱ⁾}_{,max}].

ΔIndexₛₜₑₚ_{⁽ⁱ⁾}: delta energy cost index mapped from ΔECₛₜₑₚ_{⁽ⁱ⁾} for additional load of step⁽ⁱ⁾, with range [ΔIndexₛₜₑₚ_{⁽ⁱ⁾}_{,min}, ΔIndexₛₜₑₚ_{⁽ⁱ⁾}_{,max}].

P_{3,step}_{⁽ⁱ⁾}, P_{4,step}_{⁽ⁱ⁾}: enhanced linear mapping parameters related to ΔECₛₜₑₚ_{⁽ⁱ⁾} range and ΔIndexₛₜₑₚ_{⁽ⁱ⁾} range, for additional load of step⁽ⁱ⁾.

$${P}_{3 , {step}^{( i )}} = \frac{{ΔIndex}_{s t e {p}^{( i )} , max} {ΔIndex}_{s t e {p}^{( i )} , min}}{Δ {EC}_{{step}^{( i )} , max} - Δ {EC}_{s t e {p}^{( i )} , min}} \qquad ( 6 )$$

$${P}_{4 , ste {p}^{( i )}} = \frac{Δ E {C}_{{step}^{( i )} , max} * {ΔIndex}_{{step}^{( i ) ,} min} - Δ E {C}_{{step}^{( i )} , min} * {ΔIndex}_{{step}^{( i )} , max}}{Δ E {C}_{max} - Δ E {C}_{min}}$$

Integer(·): operation to make the result to an integer, can be round (·), ceiling (·), floor (·), etc.

Additional Loadₛₜₑₚ_{⁽ⁱ⁾}: additional load levels at step⁽ⁱ⁾.

N: Total number of additional load steps

TABLE 2
P₃/P₄ parameters related to different
additional loads in different steps

| Step | P₃ | P₄ |
|---|---|---|
| Additional Loadₛₜₑₚ_{⁽¹⁾} | P_{3, step}_{⁽¹⁾} | P_{4, step}_{⁽¹⁾} |
| Additional Loadₛₜₑₚ_{⁽²⁾} | P_{3, step}_{⁽²⁾} | P_{4, step}_{⁽²⁾} |
| . . . | . . . | . . . |
| Additional Loadₛₜₑₚ_{^{(N)}} | P_{3, step}_{^{(N)}} | P_{4, step}_{^{(N)}} |

FIG. 8 illustrates an enhanced linear mapping with steps in accordance with some aspects. The configuration of different P₃/P₄ parameters related to different additional loads in different steps are shown in Table 2. Note that the delta energy cost index in different steps may not overlapping with each other as shown in FIG. 8. This has benefit especially when there is no signaling transmitted for the additional load. When a delta energy cost index integer number is received at a RAN node, the delta energy cost index integer number is understood what additional load step the delta energy cost index integer number is related to.

### Enhanced Mapping Table

The enhanced mapping table rule is a non-linear mapping between delta energy consumption and delta energy cost index, with respect to different additional load levels. The enhanced mapping table rule is illustrated in Table 3. Basically, the entire [ΔECₘᵢₙ, ΔECₘₐₓ] range is divided into small EC step ranges according to different additional load levels, while one delta energy cost index value is applied for each EC step range at different additional load level.

Note that the delta energy cost index range [ΔIndexₘᵢₙ, ΔIndexₘₐₓ] and delta EC step ranges can be defined by the operator and can be different for different gNB groups.

Additional Loadₛₜₑₚ_{⁽ⁱ⁾}: additional load level at step⁽ⁱ⁾.

ΔEC[stepₖₘᵢₙ⁽ⁱ⁾, step_{k,max}⁽ⁱ⁾: The k-th range of delta energy consumption related the additional load_step⁽ⁱ⁾.

Mᵢ: Total number of energy consumption ranges related to the additional load_step⁽ⁱ⁾.

N: Total number of additional load steps.

TABLE 3
Enhanced Mapping Table rule illustration

| Additional Load | Energy Consumption (EC) | Energy Cost Index |
|---|---|---|
| Additional | ΔEC[step_{1, min}⁽¹⁾, | ΔIndexₘᵢₙ |
| Load-_step⁽¹⁾ | step_{1, max}⁽¹⁾) | |
| | ΔEC[step_{2, min}⁽¹⁾, | ΔIndexₘᵢₙ + 1 |
| | step_{2, max}⁽¹⁾) | |
| | ΔEC[step_{3, min}⁽¹⁾, | ΔIndexₘᵢₙ + 2 |
| | step_{3, max}⁽¹⁾) | |
| | . . . | . . . |
| | ΔEC[step_{M}_{₁}_{, min}⁽¹⁾, | ΔIndexₘᵢₙ + M₁ − 1 |
| | step_{M}_{₁}_{, max}⁽¹⁾) | |
| Additional | ΔEC[step_{1, min}⁽²⁾, | ΔIndexₘᵢₙ + M₁ |
| Load-_step⁽²⁾ | step_{1, max}⁽²⁾) | |
| | ΔEC[step_{2, min}⁽²⁾, | ΔIndexₘᵢₙ + M₁ + 1 |
| | step_{2, max}⁽²⁾) | |
| | ΔEC[step_{3, min}⁽²⁾, | ΔIndexₘᵢₙ + M₁ + 2 |
| | step_{3, max}⁽²⁾) | |
| | . . . | . . . |
| | ΔEC[step_{M}_{₂}_{, min}⁽²⁾, | . . . |
| | step_{M}_{₂}_{, max}⁽²⁾) | |
| . . . | . . . | . . . |
| Additional | ΔEC[step_{1, min}^{(N)}, | . . . |
| Load-_step^{(N)} | step_{1, max}^{(N)}) | |
| | ΔEC[step_{2, min}^{(N)}, | . . . |
| | step_{2, max}^{(N)}) | |
| | ΔEC[step_{3, min}^{(N)}, | . . . |
| | step_{3, max}^{(N)}) | |
| | . . . | . . . |
| | ΔEC[step_{M}_{_{N}}_{, min}^{(N)}, | ΔIndexₘₐₓ |
| | step_{M}_{_{N}}_{, max}^{(N)}) | |

Enhanced Linear Mapping Together with Additional Load

In this mapping rule, the additional load (AL) is directly included in the equation.

$$ΔIndex = Integer ( {P}_{5} * Δ E C + {P}_{6} * A L + {P}_{7} ) \qquad ( 7 )$$

P₅, P₆, P₇: Enhanced linear mapping together with additional load (AL) parameters.

AL: The additional load parameter.

ΔEC: Measured or predicted delta energy consumption related to AL parameter.

ΔIndex: delta energy cost index mapped from ΔEC related to AL parameter.

Integer(·): operation to make the result to an integer, can be round (·), ceiling (·), floor (·), etc.

The parameters of P₅, P₆, P₇ are chosen such that when a delta energy cost index is received at a RAN node, the delta energy cost index is able to differentiate AL and ΔEC accordingly.

One embodiment of the mapping rule F is to adjust P₅, P₆, P₇ so that AL and ΔEC can be related to different digits of the delta energy cost index integer. For example, a delta energy cost index=1234, while the first two digits “12” are related to calculation from ΔEC and the last two digits “34” are related to calculation from AL, etc.

Note that with the extension of AI/ML model training at the OAM with AI/ML model inference at the NG-RAN and a CU/DU split architecture, the energy cost mapping rule here can be applied over other related interfaces like the NG interface between the NG-RAN and OAM, or the F1 interface between the CU and DU. The energy cost mapping rule can be further applied in an Open RAN (O-RAN) architecture with corresponding interfaces.

### Management of Energy Consumption to Energy Cost Index Mapping Rule

### Management Service Framework

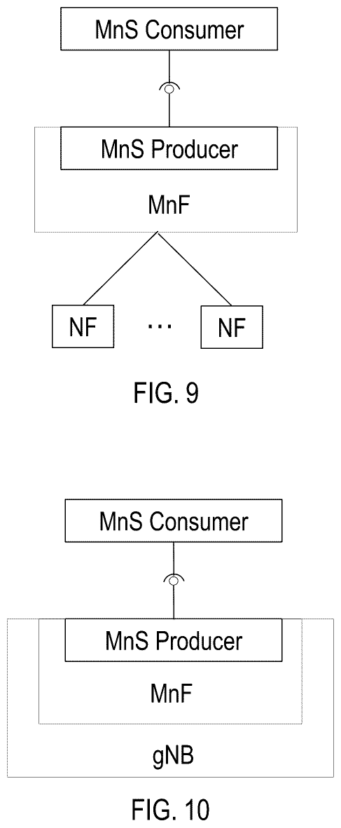

The MnS framework for managing the energy consumption to energy cost index mapping rule is illustrated by FIGS. 9 and 10. In particular, FIG. 9 illustrates a MnS framework for managing the energy consumption to energy cost index mapping rule using a standalone MnF in accordance with some aspects. FIG. 10 illustrates a MnS framework for managing the energy consumption to energy cost index mapping rule using an embedded MnF in accordance with some aspects.

The MnS consumer interacts with MnS producer for managing the energy consumption to energy cost index mapping rule. The modelling of the energy consumption to energy cost index mapping rule, which are managed as managed object instances (MOI) or attributes by the operations and notifications defined for generic provisioning management service (see clause 11.1.1 of 3GPP TS 28.532). Specifically, the MnS consumer uses the CreateMOI, getMOIAttributes, modifyMOIAttributes, deleteMOI to manage (create, modify, delete, get attributes of) the MOI representing the actions executed according to the AI/ML inference output b, and receive the corresponding notifications (notifyMOICreation, notifyMOIDeletion, notifyMOIAttributeValueChanges, notifyMOIChanges, notifyEvent).

### Information Models

Note that the names of the Information Object Class (IOC) and the attributes are not significant; the IOC can be named differently. The IOC can represent the actions executed according to the AI/ML inference output and contains the information presented by the attributes no matter with the same or different attribute names.

### Class Diagram

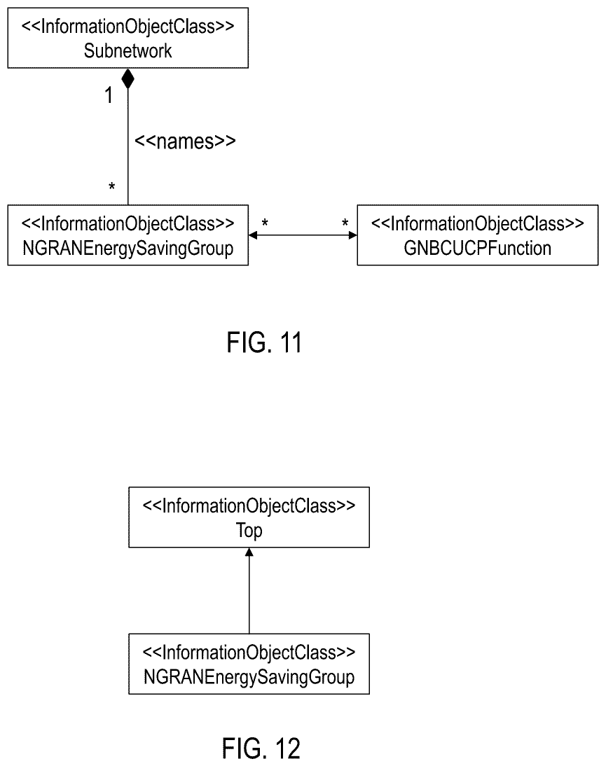

FIG. 11 illustrates a NRM fragment for NG-RAN energy saving group in accordance with some aspects. FIG. 12 illustrates an inheritance hierarchy for NG-RAN energy saving group in accordance with some aspects.

### Class Definitions

### NGRANEnergySavingGroup

### Definition

This IOC represents a group of gNBs that coordinate with each other for energy saving.

### Attributes

| | Support | | | | |
|---|---|---|---|---|---|
| | Qual- | isRead- | isWrit- | isIn- | isNoti- |
| | ifier | able | able | variant | fyable |
| Attribute name | | | | | |
| energyCostIndexMap- | M | T | T | F | T |
| pingRuleInfo | | | | | |
| Attribute related | | | | | |
| to role | | | | | |
| memberGNBRef | M | T | F | F | T |

### GNBCUCPFunction

### Definition

For non-split NG-RAN deployment scenarios, this IOC together with the GNBCUUPFunction IOC and GNBDUFunction IOC provide the management representation of gNB defined in clause 6.1.1 in 3GPP TS 38.401.

For 2-split NG-RAN deployment scenario, this IOC together with the GNBCUUPFunction IOC provide management representation of the gNB-CU defined in clause 6.1.1 in 3GPP TS 38.401.

For 3-split NG-RAN deployment scenario, this IOC provides management representation of the gNB-CU-CP defined in clause 6.1.2 in 3GPP TS 38.401.

The following table identifies the end points for the representation of gNB and en-gNB, of all deployment scenarios.

| | End point | End point | End point |
|---|---|---|---|
| | requirement for 3- | requirement for 2- | requirement for Non- |
| Req | split deployment | split deployment | split deployment |
| Role | scenario | scenario | scenario |
| gNB | <<IOC>>EP_XnC, | <<IOC>>EP_XnC, | <<IOC>>EP_XnC, |
| | <<IOC>>EP_NgC, | <<IOC>>EP_NgC, | <<IOC>>EP_NgC. |
| | <<IOC>>EP_F1C, | <<IOC>>EP_F1C. | |
| | <<IOC>>EP_E1. | | |
| en- | <<IOC>>EP_X2C, | <<IOC>>EP_X2C, | <<IOC>>EP_X2C. |
| gNB | <<IOC>>EP_F1C, | <<IOC>>EP_F1C. | |
| | <<IOC>>EP_E1. | | |

### Attributes

The GNBCUCPFunction IOC includes attributes inherited from ManagedFunction IOC (defined in TS 28.622[30]) and the following attributes:

This adds the attribute (energySavingGroupRef) to indicate the NG-RAN energy saving group(s) that the gNB CU-CU belongs to.

| | | isRead- | isWrit- | isIn- | isNoti- |
|---|---|---|---|---|---|
| | S | able | able | variant | fyable |
| Attribute name | | | | | |
| gNBId | M | T | T | F | T |
| gNBIdLength | M | T | T | F | T |
| gNBCUName | O | T | T | F | T |
| pLMNId | M | T | T | T | T |
| x2BlockList | C | T | T | F | T |
| | M | | | | |
| x2AllowList | C | T | T | F | T |
| | M | | | | |
| xnBlockList | M | T | T | F | T |
| xnAllowList | M | T | T | F | T |
| x2HOBlockList | C | T | T | F | T |
| | M | | | | |
| XnHOBlockList | M | T | T | F | T |
| mappingSetIDBack- | C | T | T | F | T |
| haulAddressList | M | | | | |
| tceIDMappingInfoList | C | T | T | F | T |
| | M | | | | |
| dDAPSHOControl | C | T | T | F | T |
| | M | | | | |
| dCHOControl | C | T | T | F | T |
| | M | | | | |
| Attribute related to role | | | | | |
| configurable5QISetRef | C | T | T | F | T |
| | O | | | | |
| dynamic5QISetRef | C | T | F | F | T |
| | O | | | | |
| ephemerisInfoSetRef | C | T | F | F | T |
| | O | | | | |
| energySavingGroupRef | C | T | T | F | T |
| | M | | | | |

### Data Type Definitions

### ECIMappingRuleInfo

### Definition

This data type represents a mapping rule between the energy consumption to energy cost index.

| | Support | | | | |
|---|---|---|---|---|---|
| | Qual- | isRead- | isWrit- | isIn- | isNoti- |
| | ifier | able | able | variant | fyable |
| Attribute name | | | | | |
| energyCostIndexMap- | M | T | T | F | T |
| pingRuleId | | | | | |
| energyCostIndexMap- | M | T | T | F | T |
| pingRule | | | | | |
| mappingTimeInterval | M | T | T | F | T |
| Attribute related | | | | | |
| to role | | | | | |
| memberGNBRef | M | T | F | F | T |

| | Documentation and | |
|---|---|---|
| Attribute Name | Allowed Values | Properties |
| energyCostIn- | The information about | type: |
| dexMap- | mapping rule between | ECIMappingRuleInfo |
| pingRuleInfo | Energy Consumption and | multiplicity: 1 |
| | Energy Cost Index | isOrdered: N/A |
| | configured by operator. | isUnique: N/A |
| | allowedValues: Not | defaultValue: None |
| | applicable | isNullable: False |
| energyCostIn- | The mapping rule between | type: string |
| dexMap- | Energy Consumption and | multiplicity: 1 |
| pingRule | Energy Cost Index. | isOrdered: N/A |
| | allowedValues: Not | isUnique: N/A |
| | applicable | defaultValue: None |
| | | isNullable: False |
| energyCostIn- | The Id of the mapping rule | type: string |
| dexMap- | between Energy | multiplicity: 1 |
| pingRuleId | Consumption and Energy | isOrdered: N/A |
| | Cost Index. | isUnique: N/A |
| | allowedValues: Not | defaultValue: None |
| | applicable | isNullable: False |
| memberGNBRef | The DN of the | type: DN |
| | GNBCUCPFunction MOI | multiplicity: * |
| | that represent the gNB | isOrdered: N/A |
| | CU-UP which is the | isUnique: N/A |
| | member of the NGRAN | defaultValue: None |
| | energy saving group. | isNullable: False |
| energySavi- | The DN of the | multiplicity: * |
| ngGroupRef | NGRANEnergySavingGroup | type: DN |
| | MOI that represent | isOrdered: N/A |
| | NG-RAN energy saving | isUnique: N/A |
| | group that the gNB | defaultValue: None |
| | belongs to. | isNullable: False |
| mappingTimeIn- | Time interval for | type: Integer |
| terval | averaging measured | multiplicity: 1 |
| | energy consumption | isOrdered: N/A |
| | values used for computing | isUnique: N/A |
| | Energy Cost Index. | defaultValue: None |
| | allowedValues: Not | isNullable: False |
| | applicable | |
| | Unit: seconds | |

### EXAMPLES

Example 1 is an apparatus of a 5th generation NodeB (gNB), the apparatus comprising a processor that configures the apparatus to: receive, from another gNB, a data collection request message; determine a unified mapping rule that is applicable to a group of gNBs within a predetermined area; use the unified mapping rule to determine an energy cost of the gNB based on measured energy consumption values of the gNB; and send, to the other gNB, a data collection update message that includes, the energy cost.

In Example 2, the subject matter of Example 1 includes, wherein the gNB is represented by a combination of a GNBCUCPFunction Information Object Class (IOC), an GNBCUUPFunction IOC and an GNBDUFunction IOC.

In Example 3, the subject matter of Example 2 includes, wherein: the GNBCUCPFunction IOC includes a mapping rule IOC that represents the unified mapping rule, and the mapping rule IOC includes a time attribute that indicates a time interval used by the gNB for averaging the measured energy consumption values for computing the energy cost.

In Example 4, the subject matter of Examples 2-3 includes, wherein: the GNBCUCPFunction IOC includes a mapping rule IOC that represents the unified mapping rule, and the mapping rule IOC includes a reference attribute that indicates an identifier of the unified mapping rule.

In Example 5, the subject matter of Examples 2-4 includes, wherein: the GNBCUCPFunction IOC includes a mapping rule IOC that represents the unified mapping rule, and the mapping rule IOC includes a minimum attribute that indicates an energy consumption value mapping to a minimum energy cost value, and a maximum attribute that indicates an energy consumption value mapping to a maximum energy cost value.

In Example 6, the subject matter of Example 5 includes, wherein the minimum attribute is based on a minimum energy consumption value among all gNBs within the group of gNBs for the unified mapping rule, and the maximum attribute is based on a maximum energy consumption value among all gNBs within the group of gNBs for the unified mapping rule.

In Example 7, the subject matter of Examples 1-6 includes, wherein the unified mapping rule includes a linear mapping between energy consumption and energy cost index.

In Example 8, the subject matter of Examples 1-7 includes, wherein the unified mapping rule includes a non-linear mapping between energy consumption and energy cost index, in which an entire range of energy consumption is divided into step ranges, each step range having a different step size to increment the energy cost index.

In Example 9, the subject matter of Examples 1-8 includes, wherein the unified mapping rule includes a delta energy cost index related to an additional load that includes at least one of a number of radio resource control (RRC) connections to be offloaded, a number of active user equipment (UEs) to be offloaded, physical resource block (PRB) usage to be offloaded, average uplink/downlink (UL/DL) Packet Data Convergence Protocol (PDCP) service data unit (SDU) data volume to be offloaded, or average UE throughput.

Example 10 is an apparatus of a 5th generation NodeB (gNB), the apparatus comprising a processor that configures the apparatus to: send, to another gNB, a data collection request message; receive, from the other gNB, a data collection update message that includes, an energy cost determined using a unified mapping rule that is applicable to the gNB and the other gNB, the unified mapping rule mapping measured energy consumption values of the gNB to the energy cost of the gNB; and determine whether to take energy saving measures based on the data collection update message.

In Example 11, the subject matter of Example 10 includes, wherein the gNB is represented by a combination of a GNBCUCPFunction Information Object Class (IOC), an GNBCUUPFunction IOC and an GNBDUFunction IOC.

In Example 12, the subject matter of Example 11 includes, wherein: the GNBCUCPFunction IOC includes a mapping rule IOC that represents the unified mapping rule, and the mapping rule IOC includes a time attribute that indicates a time interval used by the gNB for averaging the measured energy consumption values for computing the energy cost.

In Example 13, the subject matter of Examples 11-12 includes, wherein: the GNBCUCPFunction IOC includes a mapping rule IOC that represents the unified mapping rule, and the mapping rule IOC includes a reference attribute that indicates an identifier of the unified mapping rule.

In Example 14, the subject matter of Examples 11-13 includes, wherein: the GNBCUCPFunction IOC includes a mapping rule IOC that represents the unified mapping rule, and the mapping rule IOC includes a minimum attribute that indicates an energy consumption value mapping to a minimum energy cost value, and a maximum attribute that indicates an energy consumption value mapping to a maximum energy cost value.

In Example 15, the subject matter of Example 14 includes, wherein the minimum attribute is based on a minimum energy consumption value among all gNBs within a group of gNBs for the unified mapping rule, and the maximum attribute is based on a maximum energy consumption value among all gNBs within the group of gNBs for the unified mapping rule.

Example 16 is a non-transitory computer-readable storage medium that stores instructions for execution by one or more processors of an apparatus of a 5th generation NodeB (gNB), the instructions, when executed, configured to cause the apparatus to: receive, from another gNB, a data collection request message; determine a unified mapping rule that is applicable to a group of gNBs within a predetermined area; use the unified mapping rule to determine an energy cost of the gNB based on measured energy consumption values of the gNB; and send, to the other gNB, a data collection update message that includes, the energy cost.

In Example 17, the subject matter of Example 16 includes, wherein the gNB is represented by a combination of a GNBCUCPFunction Information Object Class (IOC), an GNBCUUPFunction IOC and an GNBDUFunction IOC.

In Example 18, the subject matter of Example 17 includes, wherein: the GNBCUCPFunction IOC includes a mapping rule IOC that represents the unified mapping rule, and the mapping rule IOC includes a time attribute that indicates a time interval used by the gNB for averaging the measured energy consumption values for computing the energy cost.

In Example 19, the subject matter of Examples 17-18 includes, wherein: the GNBCUCPFunction IOC includes a mapping rule IOC that represents the unified mapping rule, and the mapping rule IOC includes a reference attribute that indicates an identifier of the unified mapping rule.

In Example 20, the subject matter of Examples 17-19 includes, wherein: the GNBCUCPFunction IOC includes a mapping rule IOC that represents the unified mapping rule, the mapping rule IOC includes a minimum attribute that indicates an energy consumption value mapping to a minimum energy cost value, and a maximum attribute that indicates an energy consumption value mapping to a maximum energy cost value, and the minimum attribute is based on a minimum energy consumption value among all gNBs within the group of gNBs for the unified mapping rule, and the maximum attribute is based on a maximum energy consumption value among all gNBs within the group of gNBs for the unified mapping rule.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to indicate one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. As indicated herein, although the term “a” is used herein, one or more of the associated elements may be used in different embodiments. For example, the term “a processor” configured to carry out specific operations includes both a single processor configured to carry out all of the operations as well as multiple processors individually configured to carry out some or all of the operations (which may overlap) such that the combination of processors carry out all of the operations. Further, the term “includes” may be considered to be interpreted as “includes at least” the elements that follow.

The Abstract of the Disclosure is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An apparatus of a 5^{th} generation NodeB (gNB), the apparatus comprising a processor that configures the apparatus to:
receive, from another gNB, a data collection request message;
determine a unified mapping rule that is applicable to a group of gNBs within a predetermined area;
use the unified mapping rule to determine an energy cost of the gNB based on measured energy consumption values of the gNB; and
send, to the other gNB, a data collection update message that includes the energy cost.

2. The apparatus of claim 1, wherein the gNB is represented by a combination of a GNBCUCPFunction Information Object Class (IOC), an GNBCUUPFunction IOC and an GNBDUFunction IOC.

3. The apparatus of claim 2, wherein:
the GNBCUCPFunction IOC includes a mapping rule IOC that represents the unified mapping rule, and
the mapping rule IOC includes a time attribute that indicates a time interval used by the gNB for averaging the measured energy consumption values for computing the energy cost.

4. The apparatus of claim 2, wherein:
the GNBCUCPFunction IOC includes a mapping rule IOC that represents the unified mapping rule, and
the mapping rule IOC includes a reference attribute that indicates an identifier of the unified mapping rule.

5. The apparatus of claim 2, wherein:
the GNBCUCPFunction IOC includes a mapping rule IOC that represents the unified mapping rule, and
the mapping rule IOC includes a minimum attribute that indicates an energy consumption value mapping to a minimum energy cost value, and a maximum attribute that indicates an energy consumption value mapping to a maximum energy cost value.

6. The apparatus of claim 5, wherein the minimum attribute is based on a minimum energy consumption value among all gNBs within the group of gNBs for the unified mapping rule, and the maximum attribute is based on a maximum energy consumption value among all gNBs within the group of gNBs for the unified mapping rule.

7. The apparatus of claim 1, wherein the unified mapping rule includes a linear mapping between energy consumption and energy cost index.

8. The apparatus of claim 1, wherein the unified mapping rule includes a non-linear mapping between energy consumption and energy cost index, in which an entire range of energy consumption is divided into step ranges, each step range having a different step size to increment the energy cost index.

9. The apparatus of claim 1, wherein the unified mapping rule includes a delta energy cost index related to an additional load that includes at least one of a number of radio resource control (RRC) connections to be offloaded, a number of active user equipment (UEs) to be offloaded, physical resource block (PRB) usage to be offloaded, average uplink/downlink (UL/DL) Packet Data Convergence Protocol (PDCP) service data unit (SDU) data volume to be offloaded, or average UE throughput.

10. An apparatus of a 5^{th} generation NodeB (gNB), the apparatus comprising a processor that configures the apparatus to:
send, to another gNB, a data collection request message;
receive, from the other gNB, a data collection update message that includes an energy cost determined using a unified mapping rule that is applicable to the gNB and the other gNB, the unified mapping rule mapping measured energy consumption values of the gNB to the energy cost of the gNB; and
determine whether to take energy saving measures based on the data collection update message.

11. The apparatus of claim 10, wherein the gNB is represented by a combination of a GNBCUCPFunction Information Object Class (IOC), an GNBCUUPFunction IOC and an GNBDUFunction IOC.

12. The apparatus of claim 11, wherein:
the GNBCUCPFunction IOC includes a mapping rule IOC that represents the unified mapping rule, and
the mapping rule IOC includes a time attribute that indicates a time interval used by the gNB for averaging the measured energy consumption values for computing the energy cost.

13. The apparatus of claim 11, wherein:
the GNBCUCPFunction IOC includes a mapping rule IOC that represents the unified mapping rule, and
the mapping rule IOC includes a reference attribute that indicates an identifier of the unified mapping rule.

14. The apparatus of claim 11, wherein:
the GNBCUCPFunction IOC includes a mapping rule IOC that represents the unified mapping rule, and
the mapping rule IOC includes a minimum attribute that indicates an energy consumption value mapping to a minimum energy cost value, and a maximum attribute that indicates an energy consumption value mapping to a maximum energy cost value.

15. The apparatus of claim 14, wherein the minimum attribute is based on a minimum energy consumption value among all gNBs within a group of gNBs for the unified mapping rule, and the maximum attribute is based on a maximum energy consumption value among all gNBs within the group of gNBs for the unified mapping rule.

16. A non-transitory computer-readable storage medium that stores instructions for execution by one or more processors of an apparatus of a 5^{th} generation NodeB (gNB), the instructions, when executed, configured to cause the apparatus to:
receive, from another gNB, a data collection request message;
determine a unified mapping rule that is applicable to a group of gNBs within a predetermined area;
use the unified mapping rule to determine an energy cost of the gNB based on measured energy consumption values of the gNB; and
send, to the other gNB, a data collection update message that includes the energy cost.

17. The non-transitory computer-readable storage medium of claim 16, wherein the gNB is represented by a combination of a GNBCUCPFunction Information Object Class (IOC), an GNBCUUPFunction IOC and an GNBDUFunction IOC.

18. The non-transitory computer-readable storage medium of claim 17, wherein:
the GNBCUCPFunction IOC includes a mapping rule IOC that represents the unified mapping rule, and
the mapping rule IOC includes a time attribute that indicates a time interval used by the gNB for averaging the measured energy consumption values for computing the energy cost.

19. The non-transitory computer-readable storage medium of claim 17, wherein:
the GNBCUCPFunction IOC includes a mapping rule IOC that represents the unified mapping rule, and
the mapping rule IOC includes a reference attribute that indicates an identifier of the unified mapping rule.

20. The non-transitory computer-readable storage medium of claim 17, wherein:
the GNBCUCPFunction IOC includes a mapping rule IOC that represents the unified mapping rule,
the mapping rule IOC includes a minimum attribute that indicates an energy consumption value mapping to a minimum energy cost value, and a maximum attribute that indicates an energy consumption value mapping to a maximum energy cost value, and
the minimum attribute is based on a minimum energy consumption value among all gNBs within the group of gNBs for the unified mapping rule, and the maximum attribute is based on a maximum energy consumption value among all gNBs within the group of gNBs for the unified mapping rule.
